(19) United States
(12) Patent Application Publication
(10) Pub. No.: US 2004/0111751 A1
(43) Pub. Date: Jun. 10, 2004

(54) Anonymous ordering system

(76) Inventor: Yossi Tsuria, Jerusalem (IL)

Correspondence Address: Welsh & Katz, 22nd Floor, 120 South Riverside Plaza, Chicago, IL, 60606-3913, US

(21) Appl. No.: 10/471,380

(22) PCT Filed: Nov. 12, 2001
(86) PCT No.: PCT/IL01/01048

(51) Int. Cl. H04N 7/173; G06F 13/00; H04N 5/445; G06F 3/00; H04N 7/16

(52) U.S. Cl. 725/104; 725/87; 725/60; 725/61; 725/6; 725/25

(57) ABSTRACT

In a pay-per-item system, a method and apparatus of anonymously ordering an item, including ordering the item through an anonymizing intermediary.

### FIELD OF THE INVENTION

The present invention relates to pay television and related pay-for-electronic-item technologies generally, especially to pay-per-view systems.

### BACKGROUND OF THE INVENTION

It is known in the prior art of pay television systems to be able to order pay-per-view items via a television system. Generally, a broadcaster or other content provider is informed of the items that are ordered, whether the items are pre-ordered or ordered on impulse for immediate viewing. In impulse pay-per-view systems, which allow ordering of an item without a real-time connection to the broadcaster, the broadcaster is later notified using, for example, a call-back mechanism as is well known in the art.

Similarly, in the prior art, a subscriber to pay television may order a particular pay television service allowing the subscriber to view a plurality of items falling in a predefined category.

Systems for scrambling a television data stream are well-known in the art. One such system is described in the following U.S. Pat. No. 5,282,249 to Cohen et al.; U.S. Pat. No. 5,481,609 to Cohen et al. Scrambled television data streams described in the Cohen et al patents comprise both scrambled data representing television signals and coded control messages, also known as ECMs. The ECMs of Cohen et al comprise, in a coded form, data necessary for generating a control word (CW) which may be used to descramble the scrambled data representing television signals. An ECM is also termed a control word packet or CWP.

While the two patents to Cohen et al describe an analog system, that is, a system in which analog television data streams are broadcast to television sets, it is appreciated that similar ECM methods may also be used for digital television data streams. Generally, the scrambling techniques used for scrambling analog television signals such as, for example, the well-known “cut-and-rotate” technique, are chosen for their applicability to analog signals. In scrambling of digital television signals other scrambling techniques, well-known in the art, are used, the techniques being more appropriate to digital signals such as, for example, applying the well-known DES algorithm to the digital television signals.

References describing systems related to privacy in transmission of content include the following:

An internet article entitled “Prepaid Smart Card Techniques—A Brief Introduction and Comparison, by D. Chaum at

http://www.chaum.com/articles/Prepaid_Smart_Cad_Techniques.htm

describes a method in which a system provider receives money in advance from users and stores the corresponding value onto the users' smart cards. After accepting stored value from the smart cards of users, retailers are periodically reimbursed with actual money by system providers.

An internet article entitled “Security without Identification—Card Computers to make Big Brother Obsolete,” by D. Chaum at

http://www.chaum.com/articles/Security_Without_Identification.htm

describes a method in which a personal “card computer” is used to handle consumer payments and transactions in a way which safeguards security and privacy.

An intemet article entitled “On Electronic Commerce—How Much do You Trust Big Brother?” by D. Chaum at

http://computer.org/Internet/v1n6/w6chaum.htm

describes a method for preventing invasion of privacy.

U.S. Pat. No. 4,325,078 to Seaton et al describes a use of disposal magnetic cards for viewing a single broadcast.

U.S. Pat. No. 6,169,975 to White et al describes a method for issuance of smart cards by a vending machine.

U.S. Pat. No. 5,915,226 to Martineau describes a method of anonymous use of a prepaid smart card.

U.S. Pat. No. 5,913,203 to Wong et al describes methods for guarding the privacy of Web payments through a third party.

U.S. Pat. Nos. 4,987,593 and 4,914,698 to Chaum describe a technique for issuing and showing blind digital signatures.

U.S. Pat. No. 5,003,348 to Howitt describes impulse pay per view systems.

PCT Patent Application WO 99/66714 to Peterka describes a system that allows service providers, consumer electronics manufacturers or standards bodies to define flexible security policies for the execution of downloaded applications on digital television receivers.

U.S. Pat. No. 5,731,576 to Valadier describes a method of transaction that replenishes a microprocessor-based card.

U.S. Pat. No. 5,590,193 to Le Roux describes a method for securing access to detachable cards of the mass storage or I/O type using a password to encipher the address of the configuration register placed in the descriptor of the card, which descriptor is stored in a non-volatile memory of the card.

U.S. Pat. No. 5,264,689 to Maes et al describes memory cards, which contain rechargeable memory, and are used as a means of prepayment in installations for the dispensing of products and services.

U.S. Pat. No. 5,768,385 to Simon describes an untraceable electronic cash protocol one-way function f.sub.1 (x) to generate an image f.sub.1 (x.sub.1) from a preimage x.sub.1; sending the image f.sub.1 (x.sub.1) in an unblinded form to a second party; and receiving from the second party a note including a digital signature, wherein the note represents a commitment by the second party to credit a predetermined amount of money to a first presenter of the preimage x.sub.1 to the second party.

U.S. Pat. No. 4,484,217 to Block et al which describes a method and system for providing subscription services, particularly subscription television services, involving transmissions from a remote location to a subscriber location for which payment is required for access.

U.S. Pat. No. 6,126,069 to Stiefel et al describes anonymous use of and payment for, as well as collection of statistics, fee-based services, in particular Near-VOD services, employing a single chip card that can be used for all service providers.

U.S. Pat. No. 6,009,465 to Decker et al describes a remote video delivery system, which transmits video and text from a hotel office to hotel rooms.

U.S. Pat. No. 3,890,461 to Vogelman et al describes a subscription television receiver for receiving a scrambled television signal, which includes a card or ticket reader into which a ticket having a unique coding pattern is placed.

U.S. Pat. No. 5,070,400 to Lieberman describes a technique in which a pay television subscriber pays for viewing credits which are transmitted to the subscriber equipment from a central office, and each program is associated with a pulse having a rate corresponding to the charge per unit time for that program, and the viewing credits are debited appropriately.

U.S. Pat. No. 4,682,224 to Ragan et al describes a system for providing intelligible video program signals and corresponding video synchronization signals to authorized video displays only comprising transmitting means for transmitting scrambled signals of at least one video program; a receiver for receiving said scrambled video program signals for said at least one video program; and a descrambling unit coupled to said receiver and including an electronic ticket removably coupled to the input of said video receiver for intercepting and descrambling the at least one scrambled video program signal from said receiver and recovering the synchronizing signals, and means coupling the recovered synchronization sweep signals and the unscrambled intelligible video program signals to said video display.

D. Husemann. April-June 1999. The Smart Card: Don't Leave Home Without It. IEEE Concurrency, pp. 24-27.

S. Dokko, J. Jeon, Y. Kim. An Implementation of Prepaid Service in CDMA PCS System. 5 pages. 1998, Proceedings of the IEEE International Conference on Networks.

J. Dhem, D. Veithen, J. Quisquater. June 1996. SCALPS: Smart Card for Limited Payment Systems. IEEE Micro, pp. 42-50.

M. Milenkovic. October-December 1998. Delivering Interactive Services via a Digital TV Infrastructure. IEEE Multimedia, pp. 34-43.

An internet article entitled “The Disappearance of Telecommunications: Beyond the Physical” at

http://www.ieee.org/organizations/pubs/press/authors/saracco/cap4_a pp.htm.

An internet article entitled “Breaking Up is Hard to Do: Modeling Security Threats for Smart Cards” at

http://www.usenix.net/publications/library/proceedings/smartcard99/full_papers/schneier/schneier_html/index.htm.

An internet article entitled “Breaking Up is Hard to Do: Modeling Security Threats for Smart Cards” at

http://www.usenix.net/event/smartcard99/full_papers/schneier/schneier_html/index.htmL.

An internet article entitled “Diffuse Guide To Electronic Payment” at

http://www.diffuse.org/payguide.html.

An internet article entitled “The Regulation of Conditional Access for Digital Television Services—Oftel Guidelines” at

http://www.oftel.gov.uk/broadcast/conacc.htm.

An internet article entitled “Interactivity in 2000: An Industry Viewpoint” at

http://jiad.org/voll/nol/katz/index.html.

An internet article entitled “Case Study—Putting Interactivity in Prime Time” at

http://www.cardtechnology.com/jun00.htm.

An internet article entitled “Online Shopper—Undercover Buying, Fake Names and All” at

http://www.nytimes.com/2000/09/14/technology/14SHOP.html.

An internet article entitled “Web Sites that Help Keep You Private” at

http://www.nytimes.com/library/tech/00/06/biztech/technology/07priv.html.

An internet article entitled “Broadcast Conditional Access” at

http://www.cedmagazine.com/ced/9803/9803cc.htm.

An internet article entitled “Subscription TV—It's Your Dime” at

http://www.digitaltelevisiion.com/tvtoday/philipos/12.htm.

It is know in the art to use prior art systems of the type described above for pay-per-view ordering.

The disclosures of all references mentioned above and throughout the present specification are hereby incorporated herein by reference.

### SUMMARY OF THE INVENTION

The present invention seeks to provide an improved system for pay-per-view and pay-per-electronic-item ordering.

The prior art does not provide a convenient way for pay-per-view ordering or ordering a subscription “anonymously”, in which the broadcaster or content provider knows how many orders have been placed and controls ordering, but the broadcaster or content provider does not know who has ordered each item. Anonymous ordering of this type is believed to be particularly relevant when the content being ordered might be considered embarrassing to the consumer; for example, if “blue” movies are being ordered.

In certain preferred embodiments, the present invention is particularly suited to systems, such as that described above in U.S. Pat. No. 5,282,249 to Cohen et al. and U.S. Pat. No. 5,481,609 to Cohen et al., in which a removable security element, such as a smart card, is used to store entitlement data defaming items or services to which a user of the system is entitled. For sake of simplicity of description, such a removable security element will be referred to in the present application as a “smart card”, it being appreciated that any other appropriate form of removable security element may alternatively be used.

In a preferred embodiment of the present invention, the user removes a smart card from a set top box (STB) associated with the user's home television or entertainment system. The smart card may be the main smart card used with the STB, or may be a second or auxiliary smart card; systems using a second or auxiliary smart card are described, for example, in the following U.S. Patents:

U.S. Pat. No. 5,666,412;

U.S. Pat. No. 5,774,546; and

U.S. Pat. No. 5,878,134.

It is appreciated that the present invention is not limited to a home environment, but may be also be used in any other appropriate environment; without limiting the generality of the foregoing and for the sake of simplicity of description, a home environment is generally described in the present specification.

The user then preferably takes the smart card to an ordering location, such as a manned or unmanned kiosk.

It is appreciated that, in an alternative preferred embodiment of the present invention, the smart card may be provided at the kiosk rather than having been previously removed from the user's home or from another user location.

At the kiosk, an authorization for the desired item is preferably provided to the smart card. Communication is preferably maintained with the broadcaster or other content provider in order to ensure that the broadcaster or other content provider knows how many consumers have ordered the item, and preferably to prevent certain kinds of cheating, such as sharing a single authorization among a plurality of users.

The user then preferably returns home with the smart card having the authorization and re-inserts the smart card in the STB.

The user is thus enabled to order a pay-per-view item anonymously, and to utilize the anonymously ordered item.

There is thus provided in accordance with a preferred embodiment of the present invention, in a pay-per-item system, a method of anonymously ordering an item, the method including ordering the item through an anonymizing intermediary.

Further in accordance with a preferred embodiment of the present invention the method also includes providing a removable security element, and wherein the ordering includes placing the removable security element in removable operative association with the anonymizing intermediary, and the removable security element receiving an authorization for utilizing the item from the anonymizing intermediary.

Still further in accordance with a preferred embodiment of the present invention the removable security element includes a smart card.

Additionally in accordance with a preferred embodiment of the present invention the ordering also includes removing the removable security element from removable operative association with the anonymizing intermediary.

Moreover in accordance with a preferred embodiment of the present invention the method also includes, before the ordering, removing the removable security element from removable operative association with a set top box (STB).

Further in accordance with a preferred embodiment of the present invention the method also includes, after the ordering, placing the removable security element in removable operative association with the STB.

Still further in accordance with a preferred embodiment of the present invention the method also includes utilizing the item with the STB.

Additionally in accordance with a preferred embodiment of the present invention the removable security element receiving an authorization includes the removable security element sending an authorization request to the anonymizing intermediary, and the anonymizing intermediary sending an authorization to the removable security element.

Moreover in accordance with a preferred embodiment of the present invention the authorization request includes a disguising number, and the authorization includes an authorization disguised with the disguising number.

Further in accordance with a preferred embodiment of the present invention the method also includes the anonymizing intermediary sending an intermediary authorization request to a headend, and the anonymizing intermediary receiving the authorization from the headend.

Still further in accordance with a preferred embodiment of the present invention the method also includes the anonymizing intermediary sending an intermediary authorization request and the disguising number to the headend, and the anonymizing intermediary receiving the authorization disguised with the disguising number from the headend.

Additionally in accordance with a preferred embodiment of the present invention the pay-per-item system includes a pay television system.

Moreover in accordance with a preferred embodiment of the present invention the item includes a pay-per-view item.

Further in accordance with a preferred embodiment of the present invention the item includes a subscription.

There is also provided in accordance with another preferred embodiment of the present invention an anonymizing intermediary including a removable security element communicator for communicating with a removable security element, and an authorization provider for providing an authorization for an item to the removable security element via the removable security element communicator.

Further in accordance with a preferred embodiment of the present invention the authorization provider includes communication apparatus for communicating with a headend, and wherein the authorization provider sends an intermediary authorization request to the headend via the communication apparatus and receives the authorization from the headend via the communication apparatus.

Still further in accordance with a preferred embodiment of the present invention the removable security element communicator receives a disguising number from the removable security element and sends the disguising number to the authorization provider, and the intermediary authorization request includes the disguising number, and the authorization includes a disguised authorization disguised with the disguising number.

Additionally in accordance with a preferred embodiment of the present invention the removable security element includes a smart card.

Moreover in accordance with a preferred embodiment of the present invention the item is utilizable as part of a pay-per-item system.

Further in accordance with a preferred embodiment of the present invention the pay-per-item system includes a pay television system.

Still further in accordance with a preferred embodiment of the present invention the item includes a pay-per-view item.

Additionally in accordance with a preferred embodiment of the present invention the item includes a subscription.

### BRIEF DESCRIPTION OF THE DRAWINGS

The present invention will be understood and appreciated more fully from the following detailed description, taken in conjunction with the drawings in which:

FIG. 1 is a simplified partly pictorial, partly block diagram illustration of a pay-for-electronic-item ordering system constructed and operative in accordance with a preferred embodiment of the present invention;

FIG. 2 is a simplified block diagram illustration of a preferred implementation of a portion of the apparatus of FIG. 1; and

FIG. 3 is a simplified flowchart illustration of a preferred method of operation of the system of FIG. 1.

### DETAILED DESCRIPTION OF A PREFERRED EMBODIMENT

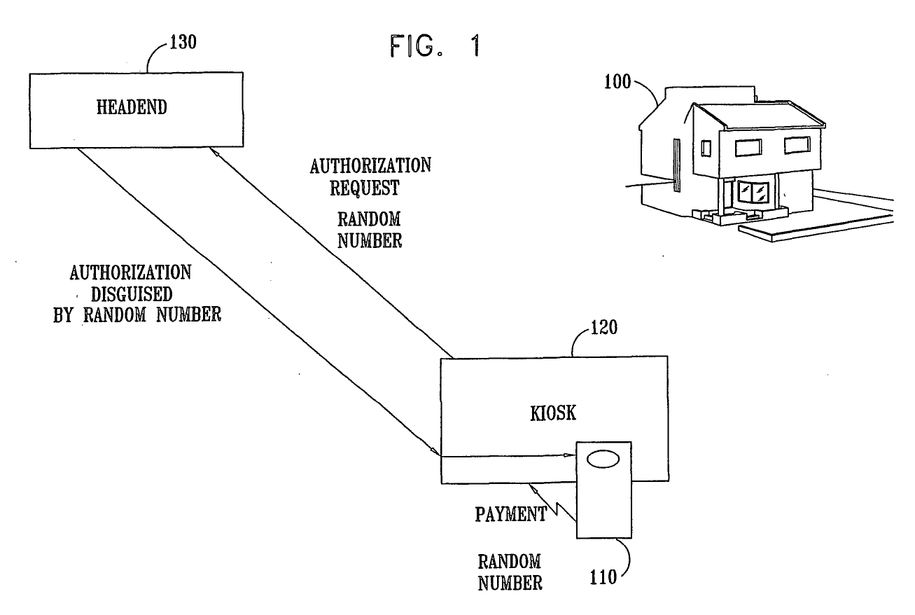

Reference is now made to FIG. 1, which is a simplified partly pictorial, partly block diagram illustration of a pay-for-electronic-item ordering system constructed and operative in accordance with a preferred embodiment of the present invention. In the system of FIG. 1, which, as described above, is particularly useful for ordering items for use with a home-based pay television or other pay entertainment system, a user (not shown) has removed, from the user's home location 100, a removable security element such as a smart card 110. For the sake of simplicity of description and without limiting the generality of the present invention, the example of the smart card 110 will generally be described in the present specification.

Typically, as described above, the smart card 110 will have been removed from an STB (not shown), as described above. It is appreciated, as described above, that the present invention is not limited to a home environment, but may be also be used in any other appropriate environment. It is further appreciated that, in an alternative preferred embodiment of the present invention, the smart card may be provided at a kiosk (see below), rather than having been previously removed from the user's home or from another user location.

As described above and as is well-known in the art, the smart card 110 preferably stores authorization information authorizing access to items to which the user is entitled.

The system of FIG. 1 comprises a kiosk 120 or other automated or semi-automated interface device, preferably comprising an appropriate smart card reader (not shown in FIG. 1) adapted to receive the smart card 110. The kiosk 120 also preferably comprises appropriate communication apparatus (not shown in FIG. 1), such as communication apparatus well known in the art, for communicating with a broadcaster-controlled or content-provider-controlled center such as a headend 130. It is appreciated that communications between the kiosk 120 and the headend 130 may be via any suitable communications channel or channels, and may or may not be secured or otherwise protected from eavesdropping and alteration, using methods well known in the art.

The operation of the system of FIG. 1 is now briefly described.

In order to purchase authorization for a particular item, the user (not shown) indicates a choice of item to the kiosk 120. The user's smart card 110 provides to the kiosk 120, typically when queried by the kiosk 120 or upon the user's indication of a choice of item:

1. payment for the item, typically comprising any appropriate payment authorization; by way of example only, such payment authorization may include debit card or credit card payment authorization; and

2. a random or pseudo-random number generated by the smart card 110 and then stored in a memory (not shown) thereof.

The kiosk 120, typically after confirming authenticity of the payment authorization, sends an authorization request and the random number to the headend 130. The kiosk 120 may also send its own payment authorization to the headend 130, or payment may be arranged by any other appropriate method.

The headend 130, if it determines that it wishes to grant the requested authorization, transmits to the kiosk 120 an authorization disguised in some appropriate reversible way by the random number. For example, and without limiting the generality of the foregoing, if the authorization comprises a number, the disguised authorization may comprise the authorization XOR the random number, where “XOR” represents an exclusive-OR operation. It is appreciated that, for a known random number r, an XOR operation using r is reversible, since:

(aXORr)XORr=a

The kiosk 120 preferably passes the disguised authorization on to the smart card 110. The smart card 110, which has stored the random number as previously described, reverses the disguising operation to obtain the authorization.

It is appreciated that, in a case where the smart card 110 comprises a secure device which has not been tampered with, and other similar smart cards (not shown) also comprise secure devices which have not been tampered with, disguising the authorization sent from the headend 130 prevents the authorization from being used by another smart card, other than the smart card 110, which has not paid for the authorization and does not have access to the random number.

Preferably, the user then returns home with the smart card 110 having the authorization and re-inserts the smart card 110 in the STB (not shown).

The user is thus enabled to order a pay-per-view item anonymously, and to utilize the ordered item.

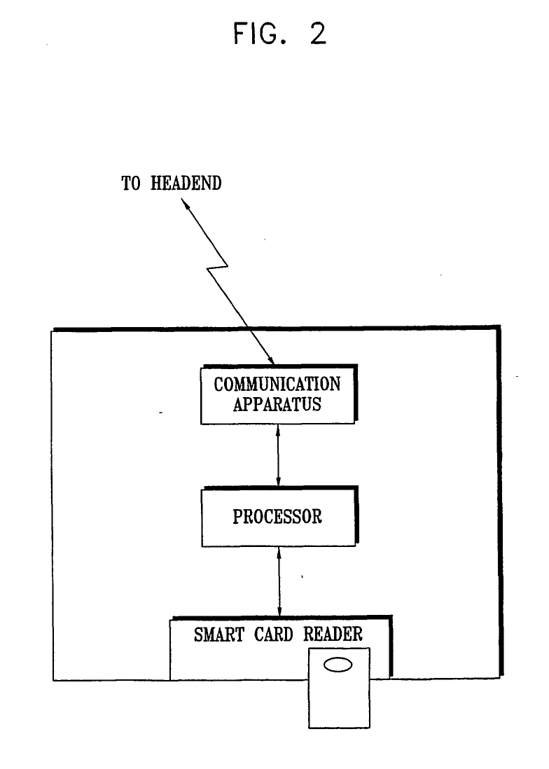

Reference is now made to FIG. 2, which is a simplified block diagram illustration of a preferred implementation of the kiosk 120 of FIG. 1. The apparatus of FIG. 2 is self-explanatory.

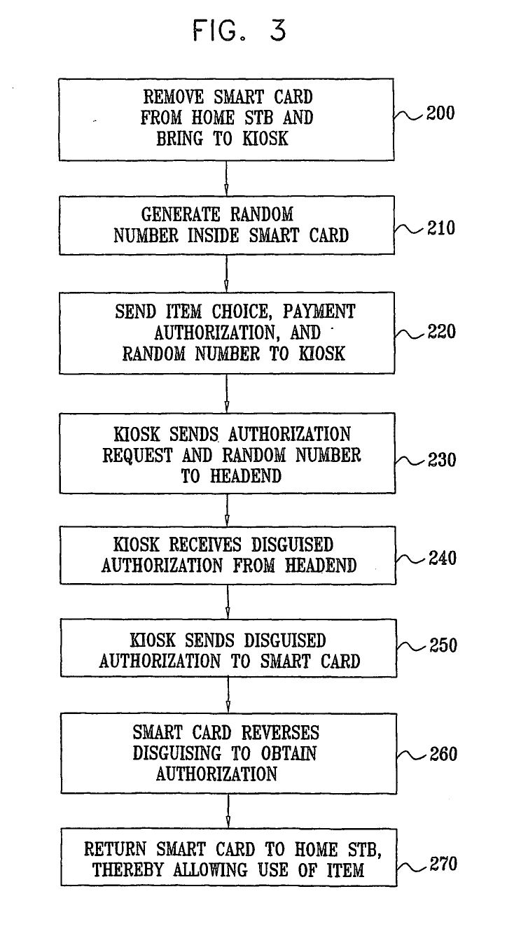

Reference is now made to FIG. 3, which is a simplified flowchart illustration of a preferred method of operation of the system of FIG. 1. The method of FIG. 3, comprising steps 200-270, is self-explanatory in light of the above discussion, except as described below.

It is appreciated that other alternative preferred methods of operation of the system of FIG. 1 may include various appropriate portions of the method of FIG. 3, such as, for example:

a) a method comprising steps 210-260 of FIG. 3, and not comprising the other steps of FIG. 3;

b) a method similar to the method of FIG. 3, but without the use of disguising using a random number; and

any appropriate combination of a and b.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather, the scope of the present invention is defined only by the claims which follow:

What is claimed is:

1. In a pay-per-item system, a method of anonymously ordering an item, the method comprising:
ordering the item through an anonymizing intermediary.

2. The method according to claim 1 and also comprising:
providing a removable security element,
and wherein the ordering comprises:
placing the removable security element in removable operative association with the anonymizing intermediary; and
the removable security element receiving an authorization for utilizing the item from the anonymizing intermediary.

3. The method according to claim 2 and wherein the removable security element comprises a smart card.

4. The method according to claim 2 and wherein the ordering also comprises:
removing the removable security element from removable operative association with the anonymizing intermediary.

5. The method according to claim 2 or claim 4 and also comprising:
before the ordering, removing the removable security element from removable operative association with a set top box (STB).

6. The method according to any of claims 2-5 and also comprising:
after the ordering, placing the removable security element in removable operative association with the STB.

7. The method according to claim 6 and also comprising:
utilizing the item with the STB.

8. The method according to any of claims 2-7 and wherein the removable security element receiving an authorization comprises:
the removable security element sending an authorization request to the anonymizing intermediary; and
the anonymizing intermediary sending an authorization to the removable security element.

9. The method according to claim 9 and wherein the authorization request comprises a disguising number, and
the authorization comprises an authorization disguised with the disguising number.

10. The method according to claim 8 or claim 9 and also comprising:
the anonymizing intermediary sending an intermediary authorization request to a headend; and
the anonymizing intermediary receiving the authorization from the headend.

11. The method according to claim 9 and also comprising:
the anonymizing intermediary sending an intermediary authorization request and the disguising number to the headend; and
the anonymizing intermediary receiving the authorization disguised with the disguising number from the headend.

12. The method according to any of claims 1-11 and wherein the pay-per-item system comprises a pay television system.

13. The method according to claim 12 and wherein the item comprises a pay-per-view item.

14. The method according to claim 12 and wherein the item comprises a subscription.

15. An anonymizing intermediary comprising:
a removable security element communicator for communicating with a removable security element; and
an authorization provider for providing an authorization for an item to the removable security element via the removable security element communicator.

16. Apparatus according to claim 15 and wherein the authorization provider comprises:
communication apparatus for communicating with a headend, and
wherein the authorization provider sends an intermediary authorization request to the headend via the communication apparatus and receives the authorization from the headend via the communication apparatus.

17. Apparatus according to claim 16 and wherein the removable security element communicator receives a disguising number from the removable security element and sends the disguising number to the authorization provider, and
the intermediary authorization request comprises the disguising number, and
the authorization comprises a disguised authorization disguised with the disguising number.

18. Apparatus according to any of claims 15-17 and wherein the removable security element comprises a smart card.

19. Apparatus according to any of claims 15-18 and wherein the item is utilizable as part of a pay-per-item system.

20. Apparatus according to claim 19 and wherein the pay-per-item system comprises a pay television system.

21. Apparatus according to claim 20 and wherein the item comprises a pay-per-view item.

22. Apparatus according to claim 20 and wherein the item comprises a subscription.
